(19) United States
(12) Patent Application Publication
(10) Pub. No.: US 2011/0016129 A1
(43) Pub. Date: Jan. 20, 2011

(54) METHOD AND SYSTEM FOR VARIABLE OR DYNAMIC CLASSIFICATION

(75) Inventor: Victor I. Sheymov, Vienna, VA (US)

Correspondence Address: The Villamar Firm PLLC, 3424 Washington Drive, Falls Church, VA, 22041, US

(73) Assignee: INVICTA NETWORKS, INC., Reston, VA (US)

(21) Appl. No.: 12/920,894

(22) PCT Filed: Mar. 3, 2009
(86) PCT No.: PCT/US09/35820

§ 371 Date: Sep. 3, 2010

Related U.S. Application Data
(60) Provisional application No. 61/033,509, filed on Mar. 4, 2008.

(51) Int. Cl. G06F 17/30

(52) U.S. Cl. 707/737; 707/E17.089

(57) ABSTRACT

A method, system and device for variable or dynamic classification of users, devices, computers, systems, or information are provided, including at least one of means for sensing one or more inputs, including at least one of an event, a parameter, and time; and means for generating a classification or policy for allowing access to information based on one or more of the sensed inputs.

### CROSS REFERENCE TO RELATED DOCUMENTS

The present invention claims benefit of priority to U.S. Provisional Patent Application Ser. No. 61/033,509 of Sheymov, entitled “METHOD AND SYSTEM FOR VARIABLE OR DYNAMIC CLASSIFICATION,” filed on Mar. 4, 2008, the entire disclosure of which is hereby incorporated by reference herein.

### BACKGROUND OF THE INVENTION

1. Field of the Invention

The present invention generally relates to systems and methods for classification of users, devices, computers, and systems, and more particularly to a system and method for variable or dynamic classification of users, devices, computers, systems, information, and the like.

2. Discussion of the Background

In recent years, systems and method for classification or systematic arrangement of users, devices, computers, and systems, etc. into groups or categories for numerous reasons, such as security, etc., have become widespread. Typically, in such systems, classification is configured as relatively static situation, employing relatively rigid processes. Such static or rigid configuration may be understandable in view of the purpose of classification itself. However, in some instances, for example, within highly dynamic environments, such static or rigid processes may lead to reduced efficiency. Therefore, there is a need for variable or dynamic classification, for example, to handle such highly dynamic environments.

### SUMMARY OF THE INVENTION

Therefore, there is a need for a method and system that address the above and other problems with systems and methods for classification of users, computers, and systems. The above and other needs are addressed by the exemplary embodiments of the present invention, which provide a novel method and system for variable or dynamic classification of users, devices, computers, systems, information, and the like.

Accordingly, in exemplary aspects of the present invention, a method, system and device for variable or dynamic classification of users, devices, computers, systems, or information are provided, including at least one of means for sensing one or more inputs, including at least one of an event, a parameter, and time; and means for generating a classification or policy for allowing access to information based on one or more of the sensed inputs.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates an exemplary system for variable or dynamic classification of users, devices, computers, systems, information, and the like; and

FIG. 2 illustrates a multidimensional structure of access security.

### DETAILED DESCRIPTION OF THE PREFERRED EMBODIMENTS

The present invention includes recognition that with highly dynamic environments, static or rigid classification processes may lead to reduced efficiency. For example, ideally, sensitive information, such as military information, and the like, is distributed on a need-to-know basis or classification. In a modern battlefield environment, such classification would limit distribution of relevant information, for example, to some category of battlefield participants not included in the need-to-know basis classification. At the same time, the dynamic nature of the modern battlefield environment may involve rapid changes of participants, as well as situational necessity for re-classification of the information needed to be distributed. Advantageously, the exemplary embodiments can dynamically re-classify one or more of the recipients of such information, the distributed information itself, and the like.

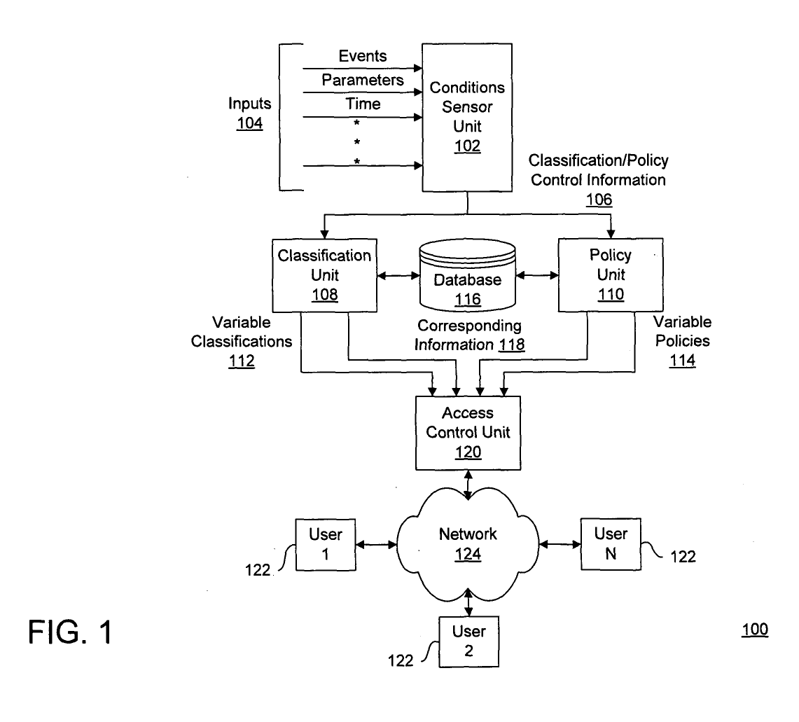

Referring now to the drawings, FIG. 1 thereof illustrates an exemplary system 100 for variable or dynamic classification of users, devices, computers, systems, information, and the like. In FIG. 1, a conditions sensor unit 102 senses various inputs 104, for example, including events (e.g., natural disaster, stock market crash, war, etc.), parameters (security level or class, etc.), time (e.g., time of day, day of week, month, year, etc.), and the like, and generates classification/policy control information 106 that is sent to a classification unit 108 and a policy unit 110 for further processing based on one or more of the sensed inputs. The classification unit 108, based on the classification control information 106, generates variable or dynamic classifications 112 for users, devices, computers, systems, information, and the like. Similarly, the policy unit 110, based on the policy control information 106, generates variable or dynamic policies 114 for users, devices, computers, systems, information, and the like. The classification unit 108 and the policy unit 110 allow access to corresponding information from a database or other content sources 116 based on the variable or the dynamic classifications 112 and policies 114, respectively.

In an exemplary embodiment, the variable or dynamic classifications 112 and/or policies 114 and the corresponding information 118, for example, can employed by an access control unit 120 to provide access to one or more users, devices, computers, systems, and the like 122 over a communications network 124. Accordingly, the exemplary system 100 illustrates the novel variable or dynamic classification, when employed, for example, as a network computer access security system. However, the exemplary embodiments are applicable to a wide variety of situations and applications where there is a need for the classification itself and/or the policy toward classes to be dynamically changed based on pending events, time, situations, participations, parameters, and the like.

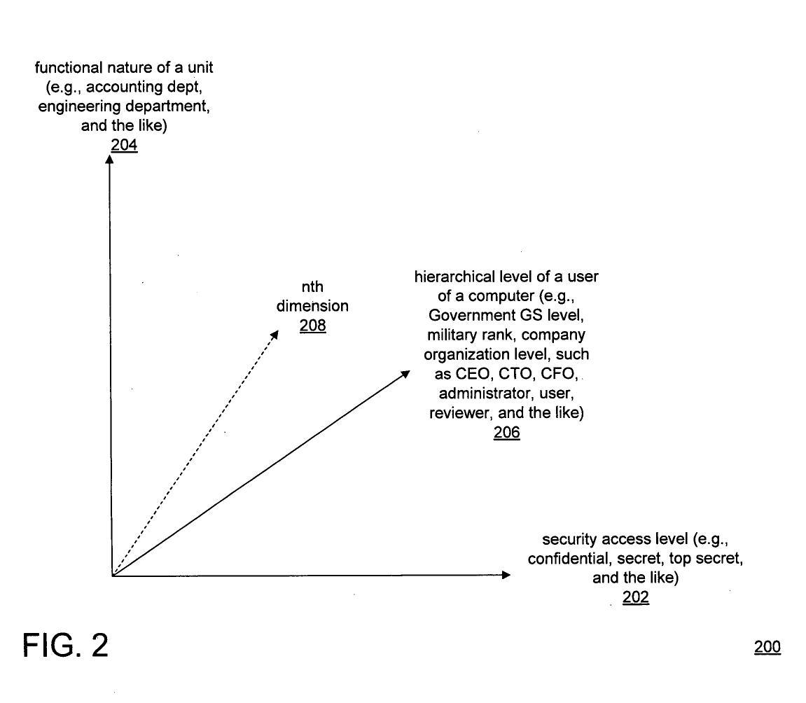

In an exemplary embodiment, for example, for sophisticated network computer access, the exemplary system 100 can be configured to accommodate a multidimensional structure 200 of access security, as shown in FIG. 2. In FIG. 2, classification within the exemplary system 100 can be made, for example, based on security access level 202 (e.g., confidential, secret, top secret, and the like) in one dimension, functional nature of a unit 204 (e.g., accounting dept, engineering department, and the like) in the second dimension, and the hierarchical level of a user of a computer 206 (e.g., Government GS level, military rank, company organization level, such as Chief Execute Officer (CEO), Chief Financial Officer (CFO), etc., administrator, user, reviewer, and the like) in the third dimension. In an exemplary embodiment, a security access policy can be implemented, for example, granting a computer access to a certain set of computers and files based on the variable or dynamic classification and/or policy. In further exemplary embodiments, various other dimensions 208 (e.g., n-dimensions) and applications can be employed, as will be appreciated by those skilled in the relevant art(s).

The exemplary system 100 thus enables modification of security access policy depending on various parameters, such as time, events, processes (e.g., such as participation in common projects), and the like. For example, the exemplary system 100 can allow only one of many classes of computers to access a network during evening hours. In further exemplary embodiments, the exemplary system 100 can be configured to block access to a certain class of computers, for example, if a security breach was detected in that class, and the like, advantageously, providing dynamic modification of access for specific classes of computers.

In further exemplary embodiments, the exemplary system 100 can be configured to react to an event, such as a declared national emergency, by limiting access to a network to only a fraction of computers within each class, in addition to limiting the access to specific classes. Advantageously, this would provide dynamic modification of the classes of the categories themselves. Thus, the exemplary system 100 can be configured to dynamically handle various events, such as a stock market crash, a communications failure, a company financial crisis, an airplane crash, a natural disaster, and the like.

Although the exemplary embodiments are described in terms of military or security environments, the exemplary embodiments applicable to any suitable environment where variable or dynamic classification can be advantageous, as will be appreciated by those skilled in the relevant art(s).

The above-described devices and subsystems of the exemplary embodiments of FIGS. 1-2 can include, for example, any suitable servers, workstations, PCs, laptop computers, PDAs, Internet appliances, handheld devices, cellular telephones, wireless devices, other electronic devices, and the like, capable of performing the processes of the exemplary embodiments of FIGS. 1-2. The devices and subsystems of the exemplary embodiments of FIGS. 1-2 can communicate with each other using any suitable protocol and can be implemented using one or more programmed computer systems or devices.

One or more interface mechanisms can be used with the exemplary embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-2 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-2 can be implemented via one or more programmed computer systems or devices.

To implement such variations as well as other variations, a single computer system can be programmed to perform the special purpose functions of one or more of the devices and subsystems of the exemplary embodiments of FIGS. 1-2. On the other hand, two or more programmed computer systems or devices can be substituted for any one of the devices and subsystems of the exemplary embodiments of FIGS. 1-2. Accordingly, principles and advantages of distributed processing, such as redundancy, replication, and the like, also can be implemented, as desired, to increase the robustness and performance the devices and subsystems of the exemplary embodiments of FIGS. 1-2.

The devices and subsystems of the exemplary embodiments of FIGS. 1-2 can store information relating to various processes described herein. This information can be stored in one or more memories, such as a hard disk, optical disk, magneto-optical disk, RAM, and the like, of the devices and subsystems of the exemplary embodiments of FIGS. 1-2. One or more databases of the devices and subsystems of the exemplary embodiments of FIGS. 1-2 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-2 can include appropriate data structures for storing data collected and/or generated by the processes of the devices and subsystems of the exemplary embodiments of FIGS. 1-2 in one or more databases thereof.

All or a portion of the devices and subsystems of the exemplary embodiments of FIGS. 1-2 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-2 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-2, for driving the devices and subsystems of the exemplary embodiments of FIGS. 1-2, for enabling the devices and subsystems of the exemplary embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-2. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

What is claimed is:

1. A system for variable or dynamic classification of users, devices, computers, systems, or information, the system comprising at least one of:
means for sensing one or more inputs, including at least one of an event, a parameter, and time; and
means for generating a classification or policy for allowing access to information based on one or more of the sensed inputs.

2. A computer-implemented method corresponding to the system of claim 1.

3. A computer program product comprising one or more computer-readable instructions corresponding to the system of claim 1.

4. The system of claim 1, comprising one or more hardware and software devices.

5. One or more devices corresponding to the system of claim 1.
